(19) United States
(12) Patent Application Publication
(10) Pub. No.: US 2007/0274735 A1
(43) Pub. Date: Nov. 29, 2007

(54) IMAGE FORMING APPARATUS, COMPUTER-READABLE STORAGE MEDIUM, IMAGE FORMING METHOD AND IMAGE FORMING SYSTEM

(75) Inventor: Yasumasa Tsukamoto, Tokyo (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 11/671,734

(22) Filed: Feb. 6, 2007

(30) Foreign Application Priority Data
May 29, 2006 (JP) 2006-147811

(51) Int. Cl. G03G 15/00

(52) U.S. Cl. 399/82

(57) ABSTRACT

Tab attribute setting device 161 adds tab attribute information indicating image forming on a tab sheet to page information of a document image designated by an operator and adds a tub dividing number to print job information. Tab dividing number setting device 163 relates identification information of a sheet tray to number of the tab sheets configuring one tab sheet bundle loaded on the sheet tray. When forming an image, judging section 164 compares the tab dividing number with the number of the tab sheets configuring one tab sheet bundle and judges whether or not the numbers thereof are equal. In case of the numbers thereof are not equal, image control section 160 outputs an image forming ceasing command to printer section 400 to cease image forming by printer section 400.

This application is based on Japanese Patent Application No. 2006-147811 filed on May 29, 2006, in Japanese Patent Office, the entire content of which is hereby incorporated by reference.

### BACKGROUND OF THE INVENTION

The present invention relates to an image forming apparatus, a computer-readable storage medium having a computer program for controlling the image forming apparatus and an image forming system to form an image on a tub sheet.

There has been known an image forming apparatus such as a copying machine and a printer capable of printing on a tab sheet (also called “index sheet”), where an index can be printed, to be used for a partition of recording sheets.

The tab sheet has a small piece of paper portion so-called “selvage” projecting at a predetermined position. This selvage may be called “tab portion”. In the tab portion, for example a page number and a title can be written.

When the tab sheet is inserted between recording sheets, a bundle of the tub sheet wherein the positions of tab sections are offset sequentially is used. In this way, by inserting the tab sheets wherein each position of the tab portion is offset in order, the partitions wherein the positions of the tab section (title) are offset each other can be formed.

Also, currently, an image such as an index for tab section is formed on a standard-size sheet and an image for a tab section is formed on the tab section of a tab sheet by reading out the document. In this case, a position of the image for the tab section formed on each document has to be matched with a position of the tab section of the tab sheet corresponding to each document.

In an image forming apparatus related to a prior art, the position of the image is shifted in a projecting direction of the tab section so as to form the image on the tab sheet in accordance with an amount of a difference in size between the standard-size document where the image for the tub section is formed and the tub sheet (for example, Patent Documents 1 and 2). Thereby, in the projecting direction of the tab section, alignment of the image and tab sheet can be conducted automatically. However, in a direction perpendicular to the projecting direction of the tab section, aligning is not conducted automatically. Thus, an operator had to align the position in the direction perpendicular to the projecting direction of the tab section.

Meanwhile, since the position of the tab section differs in accordance with number of tab sheet composing one set (hereinafter may called “tab dividing number”), the position of the image for the tab section has to be changed in accordance with the number of the tab sheets composing one tab sheet bundle so as to make the document.

For example, in case of a tab sheet bundle where one set is formed by 4 pieces of the tab sheets (a tab sheet bundle where the number of the tab sheet configuring one tab sheet bundle is “4”) and in case of a tab sheet bundle where one set is formed by 5 pieces of the tab sheets (a tab sheet bundle where the number of the tab sheets configuring one tab sheet bundle is “5”), the positions in the direction perpendicular to the projecting direction of the tab section of each tab sheet are different. Therefore, for the tab sheet bundle where the number of the tab sheets composing one sheet bundle is “4” and for the tab sheet bundle where the number of the tab sheets composing one tab sheet bundle is “5”, the position of the image for the tab section formed on each document have to be changed.

For example, as FIG. 13 shows, document bundle 710 formed for the tab sheet bundle where the number of tab sheet configuring one tab sheet bundle is “4” is configured with four pieces of documents i.e. documents 711 to 714. In each document 711 to 714, the image for the tab section is needed to be offset sequentially so as to conform with the position of the tab section of the tab sheet bundle where the number of the tab sheets configuring one tab sheet bundle is “4”. Also, document bundle 720 formed for the tab sheet bundle where the number of the tab sheet configuring one tab sheet bundle is “5” is configured with five pieces of documents i.e. documents 721 to 725. In each document 721 to 725, the image for the tab section is needed to be offset sequentially so as to conform with the position of the tab position of the tab sheet bundle where the number of the tab sheets configuring one tab sheet bundle is “5”.

Then, if the number of the tab sheets composing one tab sheet bundle is equal to the tab dividing number of documents, the position of tab section of the tab sheet bundle and the position of the image for the tab section formed on the document in the direction perpendicular to the projecting direction of the tab conform each other, and the image for the tab section is formed in the tab section of each tab sheet. On the other hand if the number of the tab sheets configuring one tab sheet bundle is not equal to the tab dividing number, the position of the tab section of the tab sheet bundle and the position of the image for the tab section formed on the document do not conform each other in the direction perpendicular to the projecting direction of the tab section, and there is a problem that the image for the tab section is formed in a position which is deviated from the tab section of each tab sheet in a direction perpendicular to the projecting direction of the tab section.

In practice, when a document having the tab dividing number of “5” forms an image on a tab sheet where the number of the tab sheets configuring one tab sheet bundle is “5”, since the tab dividing number and the number of the tab sheets configuring one tab sheet bundle are equal, the image formed on the document for the tab section is formed in the tab section. On the other hand, when a document having a tab dividing number of “5” forms an image on a tab sheet where the number of the tab sheets composing one tab sheet bundle is “4”, since the tab dividing number and the number of the tab sheets configuring one tab sheet bundle are not equal, there is a problem that the image formed on the document for the tab section is formed in a position deviated from the tab section.

Here, referring to FIG. 4, a case where the document having the tab dividing number of “5” forms the image on the tab sheet where the number of the tab sheets configuring one tab sheet bundle is “5”, and a case where the document having the tab dividing number of “5” forms the image on the tab sheet where the number of the tab sheets composing one tab sheet bundle is “4”, are explained. FIG. 14 is a figure to explain an operation of an image forming apparatus related to a prior art and to show the document and the tab sheet.

For example, a case where document 722 configuring a document having the tab dividing number of “5” forms the image on the tab sheet is explained. As FIG. 14(b) shows, when document 722 forms the image on the tab section of tab sheet 882 where the number of the tab sheets configuring one tab sheet bundle is “5”, since the tab diving number of documents and the number of the tab sheets configuring one tab sheet bundle are equal, image 722A for the tab section is formed in tab section 822A of tab sheet 822. Meanwhile, as FIG. 14(b) shows, in the image forming apparatus related to the prior art, the image position is shifted in Y direction in accordance with an amount of difference between a dimension of standard-size document 722 and a dimension in Y direction representing a projecting direction of the tab section of tab sheet 822 so as to form the image on tab sheet 822. Therefore, the positions of the image and the tab section can be matched in Y direction.

In contrast, as FIG. 14(c) shows, when document 722 forms the image for the tab section on the tab section of tab sheet 812 where the number of the tab sheets configuring one tab sheet bundle is “4”, since the tab dividing number of documents and the number of the tab sheets configuring one tab sheet bundle are not equal, image 722A for the tab section is formed, protruding from tab section 812A of tab sheet 812. As the above, in case the tab dividing number of documents and the number of the tab sheets configuring one tab sheet bundle are not equal, there is a problem that the image for the tab is formed in a position deviated from the tab section in X direction.

Namely, in the image forming apparatus related to the prior art, since the image is formed on the tab sheet by shifting the image in the protruding direction of the tab section, the positions of the image and the tab section conform each other in the protruding direction of the tab section however, since a positioning relation between the image and the tab section in the direction perpendicular to the protruding direction of the tab section is not considered, there is a problem that the positions of the image and the tab section deviate each other.

As the above, in the image forming apparatus related to the prior art, because a positioning relation between the image and the tab section in the direction perpendicular to the protruding direction of tab section is not considered, there is a problem that even in a case where the tab dividing number of documents and the number of the tab sheets configuring one tab sheet bundle are not equal by setting mistake of an operator, the image for the tab section formed on the document is formed on the tab sheet and there is occurred a failure of image forming due to discrepancy of the tab dividing number of documents and the number of the tab sheets.

### Patent document 1: Japanese Patent Non-Examined Publication No. 4-298369

### Patent document 2: Japanese Patent Non-Examined Publication No. 2003-37704

### SUMMARY OF THE INVENTION

Objects of the present invention are to solve the above problem and to provide an image forming apparatus, a computer-readable storage medium having a computer program for the image forming apparatus, an image forming method and image forming system capable of preventing the failure of image forming, in case the tab dividing number of documents and the number of the tab sheets configuring one tab sheet bundle are not equal.

Also, another object is to provide an image forming apparatus, a control program for the image forming apparatus, an image forming method and image forming system capable of automatically supplying the tab sheet which number is equal to the tab dividing number of documents so as to form the image.

In order to achieve the objects described above, this invention is made up of each of the items below.

(1) An image forming apparatus to form an image on a tab sheet provided with the tab section projecting at a prescribed position, having: an inputting section to input a tab dividing number of documents, tab attribute information to indicate forming of an image on the tab sheet, and number of the tab sheets configuring one tab sheet bundle; a memory section to memorize and connect the tab dividing number of documents, the tab attribute information and image data of the document image each other; a judging section to judge whether or not the tab dividing number of documents and the number of tab sheets configuring one tab sheet bundle are equal by comparing the tab dividing number of documents and the number of the tab sheets configuring one tab sheet bundle when the image is formed on the tab sheet based on the image data to which the tab attribute information is connected; and a control section to control the image forming apparatus base on a result of a judgment by the judging section.

(2) An image forming apparatus to form a document image on a tab sheet provided with the tab section projecting at a prescribed position, having: an inputting section to input a tab dividing number of documents, tab attribute information to indicate forming of an image on the tab sheet, and number of the tab sheets configuring one tab sheet bundle; a memory section to memorize and connect the tab dividing number of documents, the tab attribute information and image data of the document image each other; a sheet tray selection section to select a sheet tray, wherein the number of the tab sheets configuring one tab sheet bundle loaded on the sheet tray is equal to the tab dividing number of documents; and a control section to shift the image to which the tab attribute information is connected in accordance with an amount of a difference between a size of the tab sheet in a projecting direction of the tab section and a size of the image to which the tab attribute information is connected in the projecting direction of the tab section, and to form the image on the tab sheet which is loaded on the selected sheet tray.

(3) A computer-readable storage medium having a computer program stored thereon that is readable by a computer for controlling an image forming apparatus which forms an image on a tab sheet provided with the tab section projecting at a prescribed position, wherein the computer program causes the computer to execute steps of: inputting a tab dividing number of documents, tab attribute information to indicate forming of an image on the tab sheet, and number of the tab sheets configuring one tab sheet bundle; memorizing and connecting the tab dividing number of documents, the tab attribute information and image data of the document image each other; judging whether or not the tab dividing number of documents and the number of tab sheets configuring one tab sheet bundle are equal by comparing the tab dividing number of documents and the number of the tab sheets configuring one tab sheet bundle when the image is formed on the tab sheet based on the image data to which the tab attribute information is connected; and controlling the image forming apparatus base on a result of a judgment by the judging function.

(4) A computer-readable storage medium having a computer program stored thereon that is readable by a computer for controlling an image forming apparatus which forms an image on a tab sheet provided with the tab section projecting at a prescribed position, wherein the computer program causes the computer to execute steps of: inputting a tab dividing number of documents, tab attribute information to indicate forming of an image on the tab sheet, and number of the tab sheets configuring one tab sheet bundle; memorizing and connecting the tab dividing number of documents, the tab attribute information and image data of the document image each other; selecting a sheet tray wherein the number of the tab sheets configuring one tab sheet bundle loaded on the sheet tray is equal to the tab dividing number of documents; and shifting the image to which the tab attribute information is connected in accordance with an amount of a difference between a size of the tab sheet in a projecting direction of the tab section and a size of the image to which the tab attribute information is connected in the projecting direction of the tab section, and to form the image on the tab sheet which is loaded on the selected sheet tray.

(5) An image forming method to form an image on a tab sheet provided with the tab section projecting at a prescribed position, having steps of: a step of inputting a tab dividing number of documents, tab attribute information to indicate forming of an image on the tab sheet, and number of the tab sheets configuring one tab sheet bundle; a step of memorizing and connecting the tab dividing number of documents, the tab attribute information and image data of the document image each other; a step of judging whether or not the tab dividing number of documents and the number of tab sheets configuring one tab sheet bundle are equal by comparing the tab dividing number of documents and the number of tab sheets configuring one tab sheet bundle when the image is formed on the tab sheet based on the image data to which the tab attribute information is connected; and a step of announcing discrepancy between the tab dividing number of documents and the number of the tab sheets configuring one tab sheet bundle when the numbers thereof are judged to be unequal.

(6) An image forming method to form a document image not having a tab section, on a tab sheet provided with the tab section projecting at a prescribed position, having steps of: a step of inputting a tab dividing number of documents, tab attribute information to indicate forming of an image on the tab sheet, and number of the tab sheets configuring one tab sheet bundle; a step of memorizing and connecting the tab dividing number of documents, the tab attribute information and image data of the document image each other; a step of judging whether or not the tab dividing number of documents and the number of tab sheets configuring one tab sheet bundle are equal by comparing the tab dividing number of documents and the number of tab sheets configuring one tab sheet bundle when the image is formed on the tab sheet based on the image data to which the tab attribute information is connected; and a step of shifting the image to which the tab attribute information is connected, in accordance with an amount of a difference between a size of the tab sheet in a projecting direction of the tab section and a size of the image to which the tab attribute information is connected in the projecting direction of the tab section, and forming the image on the tab sheet which is loaded on the selected sheet tray when the tab dividing number of documents and the number of tab sheets configuring one tab sheet bundle are judged to be equal.

(7) An image forming method to form an image on a tab sheet provided with the tab section projecting at a prescribed position, having steps of: a step of inputting a tab dividing number of documents, tab attribute information to indicate forming of an image on the tab sheet, and number of the tab sheets configuring one tab sheet bundle; a step of memorizing and connecting the tab dividing number of documents, the tab attribute information and image data of the document image each other; a step of selecting a sheet tray wherein the number of the tab sheets configuring one tab sheet bundle loaded on the sheet tray is equal to the tab dividing number of documents; and a step of shifting the image to which the tab attribute information is connected in accordance with an amount of a difference between a size of the tab sheet in a projecting direction of the tab section and a size of the image to which the tab attribute information is connected in the projecting direction, of the tab section and forming the image on the tab sheet which is loaded on the selected sheet.

(8) An image forming system to form an image on a tab sheet provided with the tab section projecting at a prescribed position, having: an inputting section to input a tab dividing number of documents, tab attribute information to indicate forming of an image on the tab sheet and number of the tab sheets configuring one tab sheet bundle; a memory section to memorize and connect the tab dividing number of documents, the tab attribute information and image data of the document image each other; a judging section to judge whether or not the tab dividing number of documents and the number of tab sheets configuring one tab sheet bundle are equal by comparing the tab dividing number of documents and the number of tab sheets configuring one tab sheet bundle when the image is formed on the tab sheet based on the image data to which the tab attribute information is connected; and

a control section to control an image forming apparatus based on a judgment result of the judging section.

(9) An image forming system to form an image on a tab sheet provided with the tab section projecting at a prescribed position, having: an inputting section to input a tab dividing number of documents, tab attribute information to indicate forming of an image on the tab sheet, and number of the tab sheets configuring one tab sheet bundle loaded on the sheet tray; a memory section to memorize and connect the tab dividing number of documents, the tab attribute information and the image data of the document image each other; a sheet tray selecting section to select a sheet tray, wherein the number of the tab sheets configuring one tab sheet bundle loaded on the sheet tray is equal to the tab dividing number of documents; and a control section to shift the image to which the tab attribute information is connected in accordance with an amount of a difference between a size of the tab sheet in a projecting direction of the tab section and a size of the image to which the tab attribute information is connected in the projecting direction of the tab section, and to form the image on the tab sheet which is loaded on the selected sheet tray.

### BRIEF DESCRIPTION OF THE DRAWINGS

FIG. 1 is a cross sectional view indicating a schematic structure of an image forming apparatus related to an embodiment of the present invention.

FIG. 2 is a block diagram indicating a schematic structure of an image forming apparatus related to an embodiment of the present invention.

FIG. 3 is a drawing to explain print job information, page information, and image data.

FIG. 4 is a view showing a bundle of documents.

FIG. 5 is a view showing a setting screen where a tab dividing number of documents is inputted.

FIG. 6 is a view showing an assigning screen to assign sheet trays.

FIG. 7 is a view showing a setting screen on which number of the tab sheets configuring one tab sheet bundle is inputted.

FIG. 8 is a view showing an example of an error message.

FIG. 9 is a view explaining image forming operation by an image forming apparatus related to a first embodiment of the present invention.

FIG. 10 is a flow chart to explain a sequence of operation by an image forming apparatus related to the embodiment of the present invention.

FIG. 11 is a flow chart to explain a sequence of operation by an image forming apparatus related to the embodiment of the present invention.

FIG. 12 is a block diagram showing a schematic structure of an image forming apparatus related to a second embodiment of the present invention.

FIG. 13 is a view explaining a bundle of documents to form an image on a tab sheet bundle.

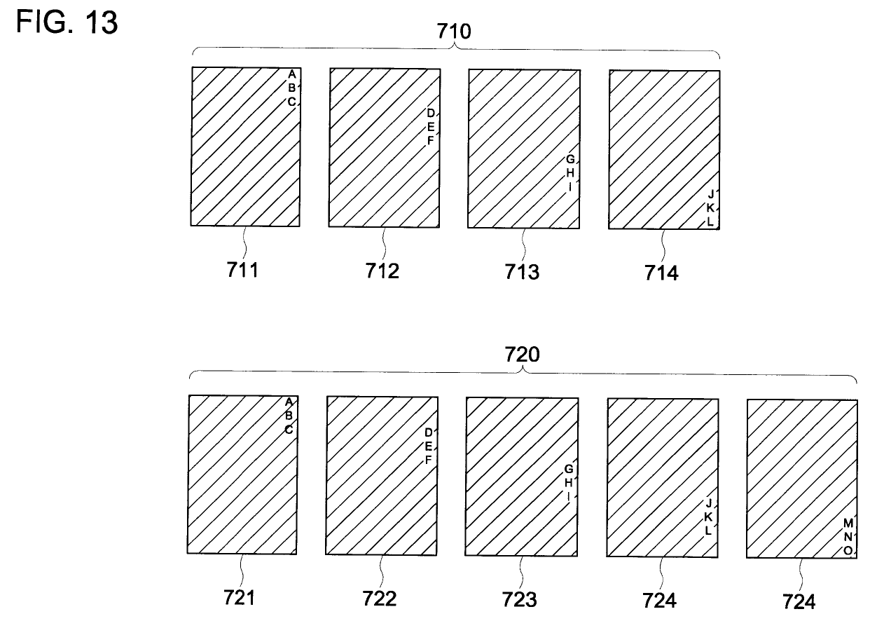

FIG. 14 is a view explaining image forming operation by an image forming apparatus related to a prior art and showing the document and the tab sheet.

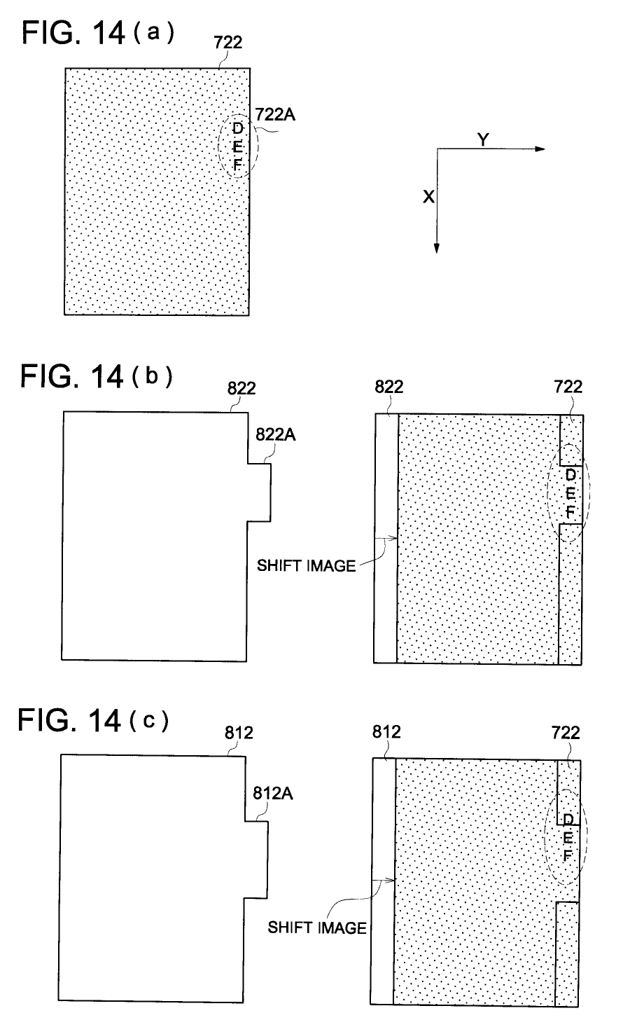

### DETAILED DESCRIPTION OF THE PREFERRED EMBODIMENT

### First Embodiment

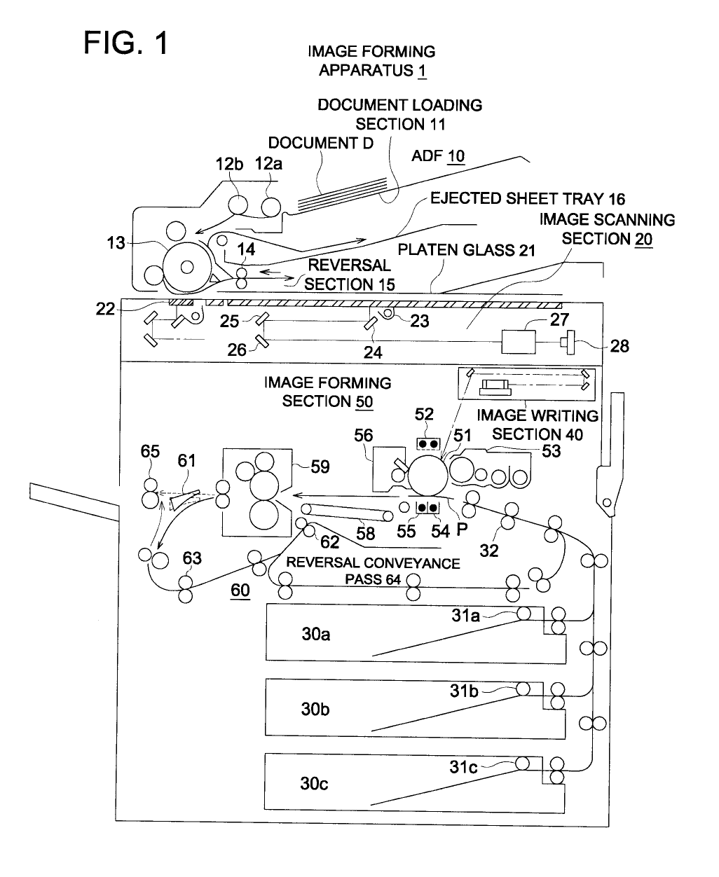

An image forming apparatus related to the first embodiment of the present invention is explained with reference to FIG. 1 to FIG. 11. A basic structure of the embodiment is an image forming apparatus provided with a function to read and to copy a copying object (a document) as image information through a document reading device (a scanner), and this embodiment can be applied to an image forming system provided with a computer and a printer, and a combination of a scanner and the system thereof.

The image forming apparatus related to this embodiment reads images on a standard-size document bundle and obtains standard-size images. The image forming apparatus adds tab attribute information indicating image forming on the tab sheet, to page information of a standard-size image to be formed on the tab sheet among standard-size images. Also, it sets the tab dividing number of documents in job information. Further, the image forming apparatus related to the embodiment correlates identification data of a sheet tray on which the tab sheet is loaded to the number of the tab sheets configuring one tab sheet bundle which is loaded on the tray thereof and memorizes the relationship. Then when the standard-size image read-in is formed, the image forming apparatus compares the tab dividing number of documents with the number of the tab sheets corresponding to the identification data of the sheet tray. If the tab dividing number of documents and the number of the tab sheets are not equal, an error massage (warning) is sent out and image forming is ceased. Thereby, it is possible to prevent image forming from the failure caused by discrepancy between the tab dividing number of documents and the number of the tab sheets configuring one tab sheet bundle.

Also, in the embodiment, while a case where the standard-size image is formed on the tab sheet using document in standard-size such as A4 size and B4 size, the size of the document (image) can be a size which is not the standard-size (non-standard size). Namely, in the embodiment, using the document (image) having a shape and a size, where the tab section is eliminated from the tab sheet, the embodiment can operate and prove an effective.

Hereinafter, configurations and functions of the image forming apparatus related to the embodiment will be explained.

<Configuration>(Mechanical Structure of Image Forming Apparatus)

First, with reference to FIG. 1, a mechanical structure of the image forming apparatus will be explained. FIG. 1 is a cross-sectional view showing a schematic structure of the image forming apparatus related to the first embodiment of the present invention. Meanwhile, here, a copying machine to read an image of a document and to form an image is explained as a concrete example of the embodiment.

A document conveyance device 10 (hereinafter may called “ADF”) is a device to convey the document and feed a sheet so as to read one side or both sides of the document. Image reading section 20 optically scans the document to form image data. Image writing section 40 records image data on recording medium P (called “recording sheet” or “transfer sheet”) by a static electric method. Sheet ejecting section 60 ejects the recording sheet.

ADF 10 is a device to conduct conveyance for reading the document. On document placing section 11 to place the document, a plurality of documents D are placed with a surface of its first page up. Document D is sent out through roller 12a and roller 12b, then conveyed to image reading section 20 through roller 13.

Thereafter, a document surface of document D is irradiated by light source 23 of image reading section 20, and a reflected light forms an image on a light receiving surface of photoelectric conversion section 28 configured with CCD (reading out element) through mirror 24, mirror 25, mirror 26 and imaging optical system 27. Image reading section 20 is configured with light source 23, mirrors 24, 25 and 26, imaging optical system 27, photoelectric conversion section 28 and optical system driving section (unillustrated). Here, light source 23 is configured with a bar shaped xenon lamp, which is longitudinal in a main scanning direction.

Meanwhile, in case scanning is conducted on platen glass 21 while a scanning surface of document D faces down, an optical system scans along platen glass 21 to conduct reading out.

Also, in case scanning is carried out while document D is being conveyed, light source 23 and mirror 24 move beneath the platen glass 22 and then stay to scan. Then the scanned image data of document D is sent from photoelectric conversion section 28 to an image processing section (unillustrated).

Meanwhile, in case document D is conveyed reversibly through document conveyance device 10, after scanning an obverse side of the document D, document D is conveyed back to roller 13 again through reversal roller 14 of reversal section 15, then a reverse side of document D is scanned by image scanning section 20 and the image data scanned is sent from photoelectric conversion section 28 to the image processing section. Document D wherein both the obverse and reverse sides are scanned is reversed again by reversal roller 14 to be loaded onto sheet ejection tray 16.

As the above, after a predetermined image processing is conducted for the image data scanned by image scanning section 20, the image data is compressed by a compressing and extension circuit and recorded in a image memory.

On the other hand, recording sheet P is fed from one of sheet feeding tray 30a, sheet feeding tray 30b or sheet feeding tray 30c in which sheets P are leaded through sheet feeding roller 31a, sheet feeding roller 31b and sheet roller 31c and conveyed to image forming section 50. Meanwhile, to load the recording sheets having different sizes, a plurality of sheet feeding trays are usually provided.

Recording sheet P to be conveyed to image forming section 50 hits a nip section of resist roller 32 through a loop roller and stops instantly so as to correct a skew of sheet P in a conveyance direction. Thereafter, recording sheet P is conveyed to photoconductive drum 51 of image forming section 50 in a predetermined timing. Image forming section 50 records a static electric latent image formed on photoconductive drum 51 on recording sheet P with an electrophotographic method.

Firstly, the image data is inputted from a writing processing section to image writing section 40. Then a laser beam corresponding to the image data is radiated on photoconductive drum 51, which is evenly charged by charging section 52, from a laser diode in image writing section 40 to form a static electric latent image. A toner image is formed on photoconductive drum 51 by developing this static electric latent image with developing section 53.

This toner image is transferred onto recording sheet P through transfer section 54 provided at a lower section of photoconductive drum 51. Then, recording sheet P adhered on photoconductive drum 51 by a pressure is separated by separating section 55. Recording sheet P separated from the photoconductive drum 51 is conveyed to fixing section 59 through conveyance mechanism 58.

Fixing section 59 fixes a toner image transferred on recording sheet P by heat and a pressure. The toner image transferred on recording sheet P is fixed by heat and a pressure from fixing roller. Thus the image is formed on recording sheet P.

Then, sheet ejecting section 60 ejects recording sheet P on which the image is fixed. Recording sheet P on which the image is fixed is ejected onto a sheet ejecting tray through sheet ejecting roller 65.

Also, in case the images are formed on both sides of recording sheet P, after the image is formed and fixed on the obverse side, recording sheet P is conveyed to reversal section 63 by guide 61. Next, recording sheet P conveyed to reversal section 63 is fed again by reversal roller 62 and conveyed to image forming section 50 again through reversal conveyance path 64.

In image forming section 50, after image forming on one side of document D is completed, toner adhering on photoconductive drum 51 is removed by cleaning section 56, and photoconductive drum 51 is charged by charging section 52 to be ready for next image forming.

In this status, recording sheet P is conveyed to image forming section 50, and an image is formed on a surface where the image is not formed (reverse side). Then, recording sheet P separated from photoconductive drum 51 by separating section 55 is conveyed again to fixing section 59 through conveyance mechanism 58. In this way, recording sheet P wherein image fixing is completed on the obverse and reverse side is ejected to the sheet ejecting tray through sheet ejecting roller 65.

<Control System of Image Forming Device>

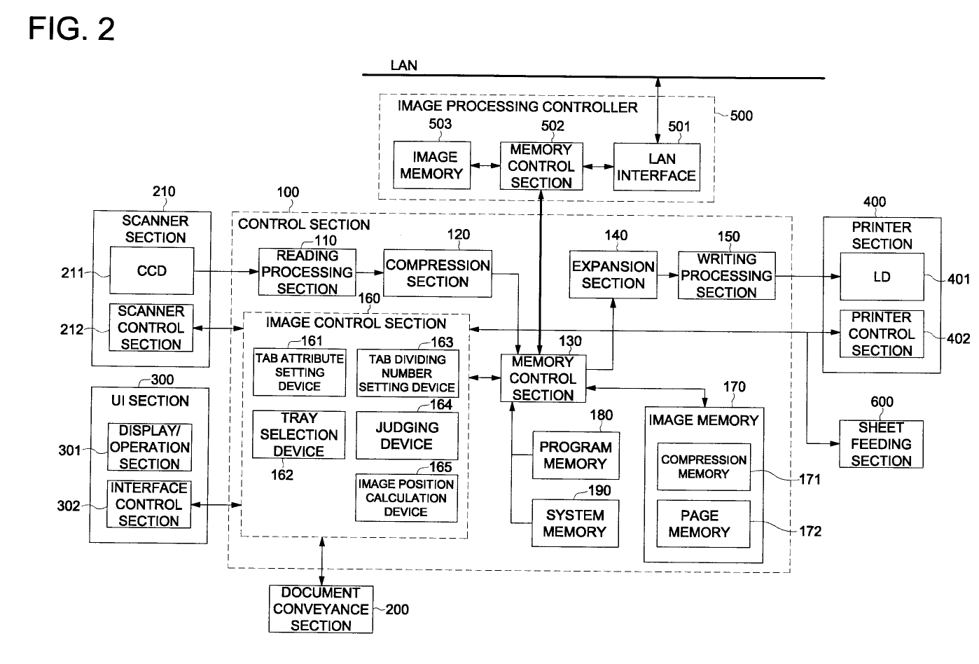

Next, with reference to FIG. 2, a configuration of a control system of an image forming apparatus related to the first embodiment of the present invention will be explained. FIG. 2 is a block diagram showing a schematic configuration of an image forming apparatus related to the first embodiment of the present invention.

Control section 100 provides scanning processing section 110, compression section 120 to compress an image data, expansion section 140 to expand the image data, writing section 150 to conduct a writing process of the image data, image memory 170 to memorize image data, memory control section 130 to control input and output of data for image memory 170, image control section 160 (CPU) to control each section, and program memory 180 and system memory 190 to memorize programs and data to activate image control section 160.

In document conveyance section 200 corresponding to document conveyance device 10 shown in FIG. 1, feeds a sheet for scanning one side or both sides of the document while conveying the document.

Scanner section 210 corresponding to image scanning section 20 shown in FIG. 1 is provided with CCD 211 and scanner control section 212 to control it.

Printer section 400 corresponding to image writing section 40 and image forming section 50 shown in FIG. 1 is provided with LD 401 and printer control section 402.

UI (user interface) section 300, so called man-machine interface is provided with a display/operation section 301 and interface control section 302 to control display/operation section 301.

Image processing controller 500 is to send and receive the image data through a network to/from a terminal (personal computer) and configured with network interface section 501, memory control section 502 and image memory 503.

Total operation of the image forming apparatus shown in FIG. 2 is explained using function of each section.

<Scanning Image Data −1>(Scanning and Reception of the Image Data from Scanner Section 210)

An image of a document is read by CCD 211, image data read is converted into a prescribed digital data form by scanning processing section 110, and compression section 120 conducts data compression for the digital data. Thereafter, memory control section 130 stores the digital data as an image data for a print job in compression memory 171 of image memory 170 so as to be able to read out from compression memory 171 by print job ID (print job identifying information such as a reception number and a reservation order). An instruction and operation of read-in the image data are controlled by scanner control section 203 through interface control section 302 and image control section 160 based on an command from display/operation section 301. Scanner control section 203 controls to instruct starting and to operate so as to reading in the image data through interface control section 302 and image control section 160 based on an instruction from display/operation section 301.

At this stage, output conditions including information such as identification data of a print job ordering party, a size of recording sheet, information of sheet type and number of the sheet outputted are sent from display/operation section 301 to image control section 160 and memorized in system memory 190 as job information while they are connected with print job ID.

<Scanning Image Data −2>(Data Download and Reception from the Network)

Image data from a terminal (personal computer) is received by LAN interface section 501 representing network interface in image process controller 500 and is temporally memorized in image memory 503 by memory control section 502. Thereafter, the image data is memorized in page memory 172 through a bus and memory control section 130. Then memory control section 130 reads out the image data from page memory 172 and inputs it to compression section 120 to compress it, and then a compressed image data is memorized in compressed memory 171. At this stage, the image data is memorized so that it can be retrieved by a print job ID.

Also, output conditions including information such as identification data of a print job ordering party, a size of the recording sheet, information of the sheet type and number of the sheet to be outputted are sent to image control section 160 through the network and memorized in system memory 190 as job information so as to be corresponded with relevant print job ID.

<Output of the Image>(Output to Printer Section 400)

Memory control section 130 reads out a print job under control of image control section 160 from compression memory 170 and outputs it to expansion section 140 representing data expansion device to decompress the image data of the print job. Writing processing section 150 sends the image data to LD 40 representing a laser diode of printer section 400 to output the image to LD40. At this stage, printer control section 402 conducts a process conforming with the output conditions from image control section 160 and causes LD 401 to output the image. Also, sheet feeding section 600 automatically feeds a desired sheet based on an instruction from image control section 160.

Meanwhile, Program memory 180 is configured with ROM and stores a program to activate image control section (CPU). System memory 190 is configured with RAM and stores information set and inputted through user interface section 300 and information to operate system by executing the above program.

(A Configuration of Image Control Section 160)

Next, a configuration and functions of image forming section 160 is explained, which is a portion featuring the image forming apparatus related to the embodiment.

Tub attribute setting device 161 adds tab attribute information to page information of standard image data inputted, and adds a tab dividing number of documents to the print job information. For example, when a page number of the document bundle in which an image formed on a tab sheet is inputted at display/operation section 301, tab attribute setting device 161 adds the tab attribute information indicating image forming on the tab sheet to the page information of standard-shaped image data of the page number among inputted standard-shaped image data. Further, when the tab dividing number of documents is inputted at display/operation section 301, tab attribute setting device 161 adds the tab dividing number to the print job information.

Meanwhile, in case the image date and the print job information are sent from a driver to image forming apparatus, since they are sent in a status where the tab attribute information is already added to the page information of the standard-shaped image data, and the tab dividing number of documents is added to the print job information, tab attribute setting device 161 does not add the tab attribute information to the page information and the tab dividing number is not added to the print job information. In this case, standard-shaped image data inputted is memorized in compression memory 171 and the print job information is memorized in system memory 190.

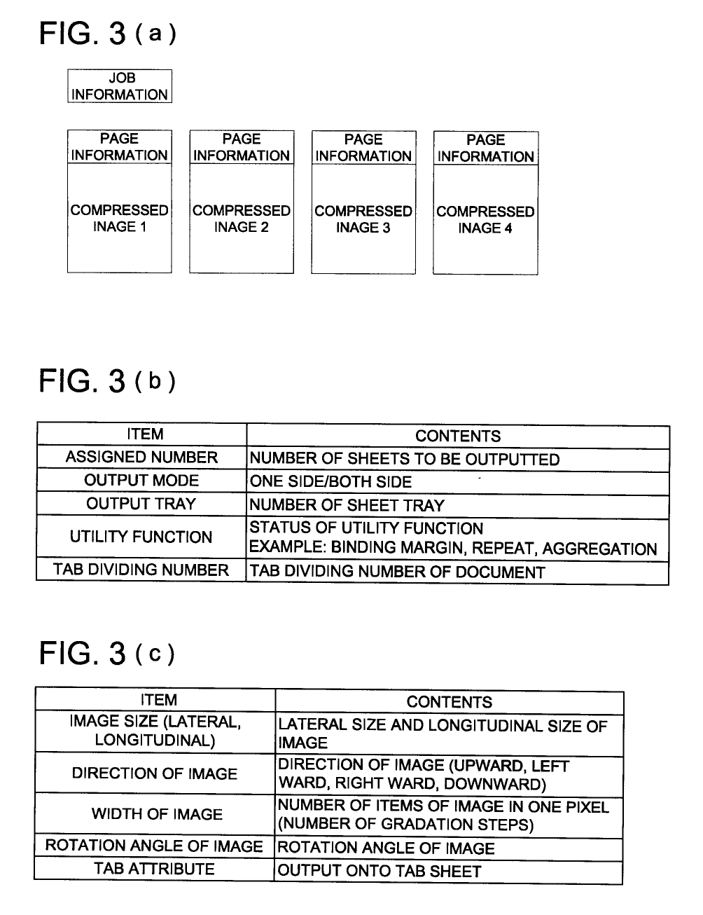

Here, examples of configurations of the print job information, the page information and the image data is explained with reference to FIG. 3(a) to FIG. 3(b). As FIG. 3(a) shows, information inputted into image forming apparatus 1 includes print job information and compressed image data. Also, the page information is added to each compressed image data. In the print job information, setting information concerning total print job is included and in the page information, information for each page is included. For example, as FIG. (3) shows, in the print job information, numbers of sheets to be outputted and sheet tray numbers are included. Also, as FIG. 3(c) shows, in the page information, an image size (a document size) is included.

Then, as FIG. 3(b) shows, tab attribute setting device 161 adds the tab dividing number of documents to the print job information. Further, as FIG. 3(c) shows tab attribute setting device 161 adds the tab attribute information to the page information of compressed image data of an assigned page. Here, in case the tab attribute information includes data instructing output to the tab sheet, an image corresponding to the image data of the page is outputted to the tab sheet.

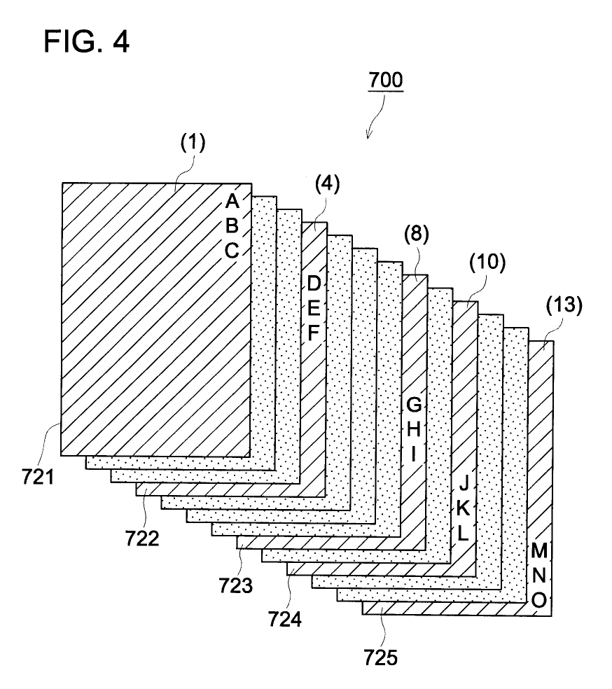

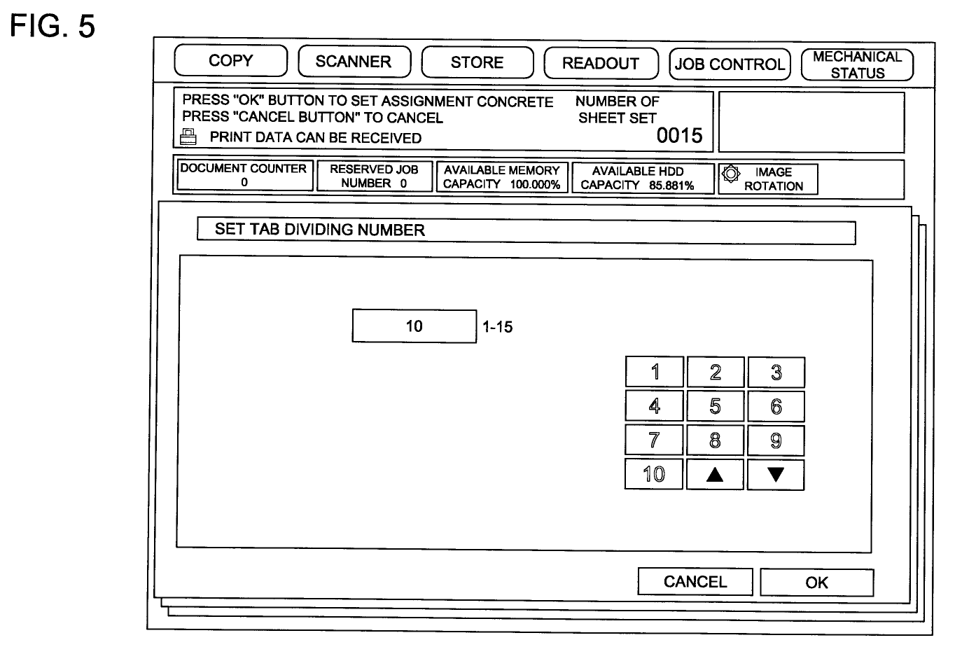

Here, a concrete example is explained with reference to FIG. 4 and FIG. 5. FIG. 4 shows a bundle of the documents. FIG. 5 shows a setting screen on which the tab dividing number of documents is inputted.

For example, as FIG. 4 shows, in case page 1, page 4, page 8, page 10 and page 13 in document bundle 700 composed of 13 pieces of the documents are used as documents for the tab sheets, an operator assigns page 1, page 4, page 8, page 10 and page 13 as the documents for the tab sheets through display/operation section 301, and further inputs the tab dividing number of documents 721 to 725. In the figure, the page numbers are represented by (1), (4), (8), (10) and (13). In this example, in case document images of documents 721 to 725 are formed on a tab sheet set, the number of sheets configures the tab sheet set has to be “5” (one set is configured with five tab sheets), in other ward, one tab sheet set has to have the tab dividing number of “5”, in order to form the document images in appropriate positions. Therefore the value “5” is to be inputted.

FIG. 5 shows an example of setting screen indicated on display/operation section 301 in the above case. The operator inputs, for example, the tab dividing number of documents on the setting screen shown in FIG. 5.

Meanwhile, the image for the tab has to be formed in advance to conform with the position of the tab section on the tab sheets. In the example shown in FIG. 4, since documents 721 to 725 are used for image forming on the tab sheet bundle where the number of the tab sheets configuring one tab sheet bundle is “5”, the operator has to form in advance the images for the tab sections of documents 721 to 725 so as to conform with the positions of the tab sections of the tab sheet bundle where the number of the tab sheets configuring one tab sheet bundle is “5”.

As the above, when the tab dividing number of documents is inputted, tab attribute setting device 16 adds the tab dividing number to the print job information of the image data. Further, tab attribute setting device 161 adds the tab attribute information to page information of the image data corresponding to a page assigned. Namely, in the present embodiment, the tab attribute information indicating image forming on the tab sheets is added to each item of page information corresponding to the image data of page 1, page 4, page 8, page 10 and page 13.

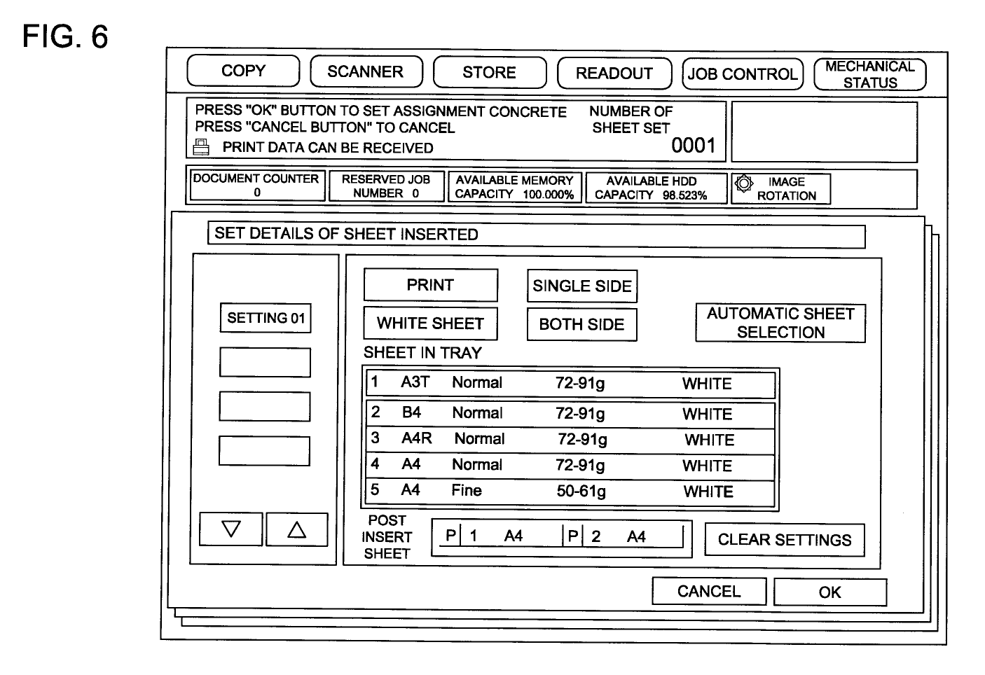

Tray selecting device 162 adds identification data (number) of a sheet tray assigned through display/operation section 301 to the print job information. FIG. 6 shows an example of an setting screen where the sheet tray is assigned. In the setting screen, a size and a kind of sheet loaded on the sheet tray are displayed. The operator can assign the sheet tray on which desired sheets are loaded with reference to the screen. Also, the operator assigns the sheet tray on which the desired sheets are loaded by using display/operation.

Tab dividing number setting device 163 relates identification data (number) of the sheet tray assigned by the operator to the number of the tab sheets configuring one set of the tab sheet bundle and stores them into system memory 190. Namely, tab dividing number setting device 163 relates the number of the tab sheets configuring one tab sheet bundle to the identification data of the sheet tray on which the tab sheets are loaded.

Also, in case a plurality of the sheet trays are assigned and the number of the tab sheets loaded on each sheet tray is inputted, tab dividing number setting device 163 relates the identification data of each sheet tray to the number of the tab sheets configuring one set of the tab sheet bundle, number which is inputted for each sheet tray, and stores into system memory 190.

Also, in case information such as the size and the kind of the tab sheet is inputted, tab dividing number setting device 163 relates the size and the kind of the sheet besides the tab dividing number to the identification data of the sheet tray and store them into system memory 190.

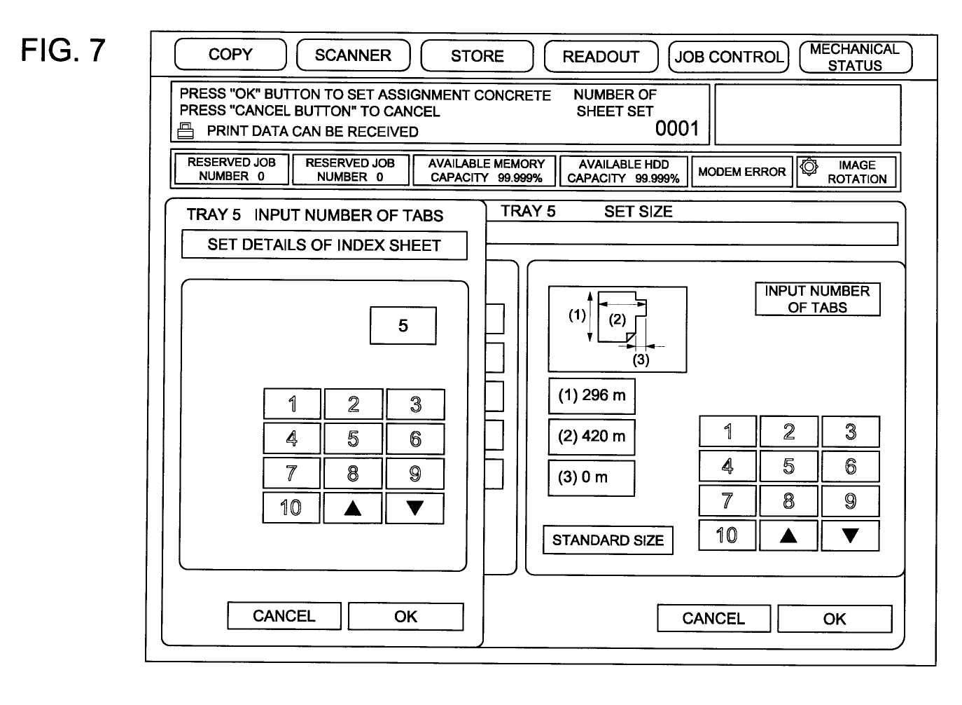

Here, FIG. 7 shows an example of an setting screen as to the information of the tab sheet. FIG. 7 shows an inputting screen where the number of the tab sheet configuring one set of the tab sheet bundle (hereinafter may called “tab number”) is inputted. The setting screen shown by FIG. 7 is displayed on display/operation section 301. The operator inputs the number of the tab sheets configuring one tab sheet bundle. Further, information such as the size and the kind of tab sheet can also be inputted on the setting screen.

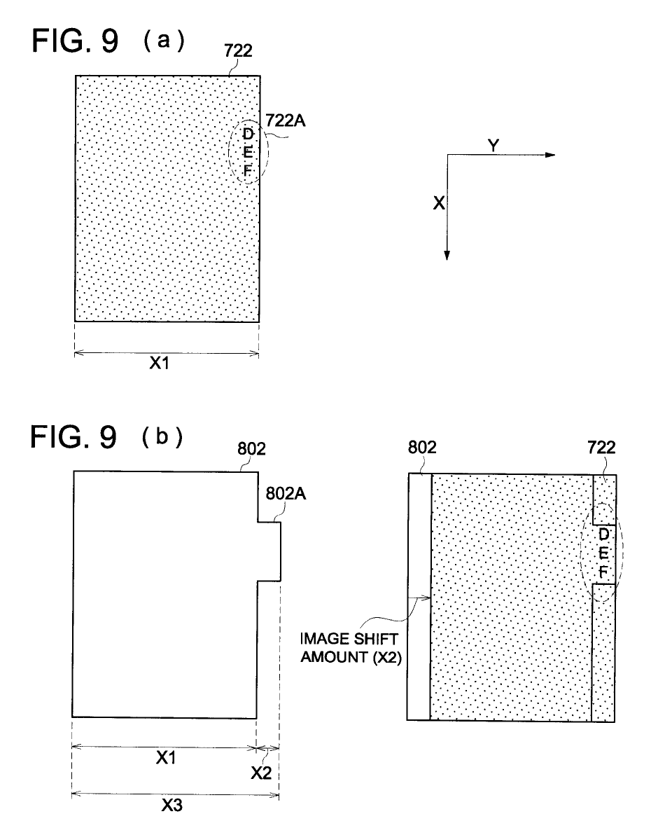

For example, information such as a width of the tab sheet in a direction (a main scanning direction in the present invention) perpendicular to a tab section projecting direction, a width of the tab sheet in a tab section projecting direction (a sub-scanning direction in the present invention) and a width of the tab section in the sub-scanning direction can be inputted. An example of an item of information inputted is shown in FIG. 9(a) and FIG. 9(b). FIG. 9(a) and FIG.(b) explain image forming operation by an image forming apparatus related to the first embodiment of the present invention and show the document and the tab sheet. For example, as FIG. 9(b) shows, a width of tab sheet 802 in the main scanning direction, a width of the tab sheet X3 in the sub-scanning and a width of tab section 802A in the sub-scanning direction X2 are inputted. The tab sheet size and kind inputted in the above way, are related to sheet tray identification data (number) by tab dividing number setting device 163 and store into system memory 190 along with the number of the tab sheets configuring one set of the tab sheet bundle. Meanwhile, in the present embodiment, the size of the tab sheet and the number of the tab sheets configuring one tab sheet bundle are related to the identification data of each sheet tray prior to the image data is inputted into the image forming apparatus.

When standard-shaped image data to form an image is received, judging device 164 judges whether or not the tab attribute information is added to the standard-shaped image data. Then in case the tab attribute information is added, judging device 164 compares the tab dividing number of the image data (document) included in the print job information with the number of the tab sheets configuring one tab sheet bundle loaded on the sheet tray designated by the operator, and judges if the tab dividing number of documents is equal to the number of the tab sheets configuring one tab sheet bundle. To do this, judging device 164 retrieves the number of the tab sheets configuring one tab sheet bundle (the number of the tab sheets configuring one tab sheet bundle loaded on the designated sheet tray) related to the identification data with the identification data (number) of the sheet tray designated by the operator as an retrieving condition. Further, judging device 164 compares the tab dividing number of standard-shaped image data (document) with the number of the tab sheets configuring one tab sheet bundle and judges whether or not the tab dividing number of document is equal to the number of the tab sheets configuring one tab sheet bundle. Meanwhile, this judging device 164 represents “judging device” of the present invention.

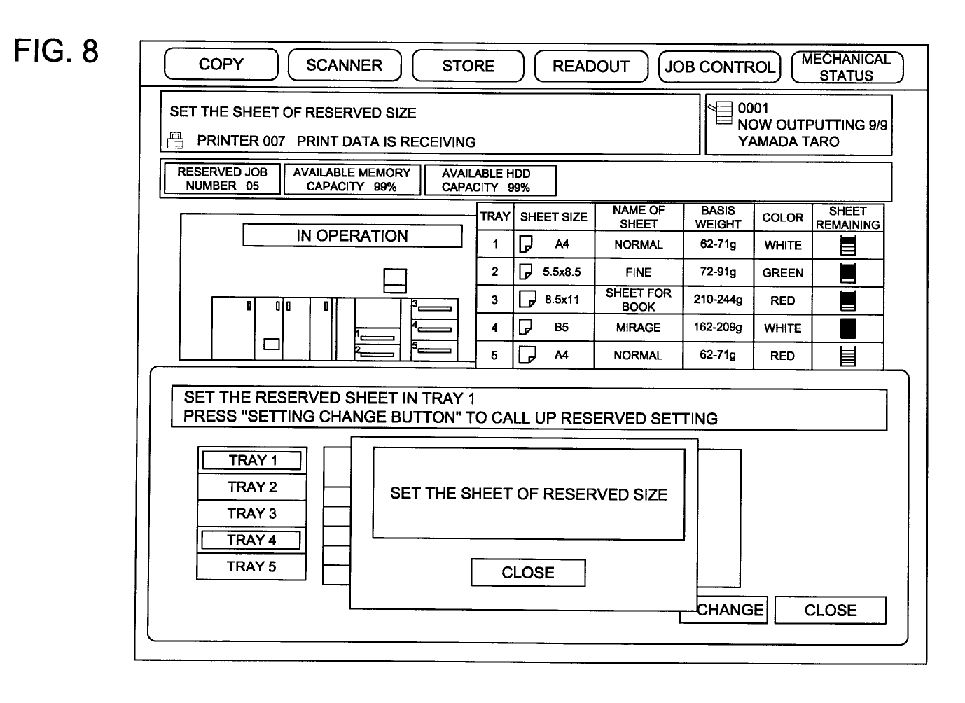

When judging device 164 judges that the tab dividing number of documents is not equal to the number of the tab sheets configuring one tab sheet bundle, image control section 160 outputs information indicates that the tab dividing number is not equal to the number of the tab sheets to UI section 300. When interface control section 302 of UI section 300 receives the information thereof, interface control section 302 causes display/operation section 301 to display that the tab dividing number of documents is not equal to the number of the tab sheets configuring one tab sheet bundle. An example of the above display is shown in FIG. 8. FIG. 8 shows a view of a screen indicating an example of the error massage. For example, as FIG. 8 shows, interface control section 302 causes display/operation section 301 to display an error message (warning). Meanwhile, UI section 300 represents “announcing device” of the present invention.

Then, image control section 160 outputs an image forming ceasing command to printer section 400. Printer section 402 ceases image forming when the image forming ceasing command is received. Thereby in case the tab dividing number of documents are not equal to the number of the tab sheets configuring one tab sheet bundle, it is possible to prevent a failure that an image for the tab section is formed in a position which is deviated from the tab section. Meanwhile, image control device 160 represents “control device” of the present invention.

On the other hand, judging device 164 judges that the tab dividing number of documents is equal to the number of the tab sheets configuring one tab sheet bundle, image position calculation device 165 calculates a difference of sizes between a document image and the tab sheet in the tab section projecting direction. Thus a position which is shifted the difference of sizes in projecting direction of tab becomes a position on the tab sheet where the document image is formed. For example, image position calculation device 165 calculates the difference between a size of tab sheet related to the identification data of the sheet tray in the tab section projecting direction (tab sheet size (2) inputted in the setting screen in FIG. 7) and a size of the tab section of the document image scanned, so that a position which is shifted the difference of sizes in the sub-scanning direction representing the tab projecting direction becomes a position where document image is formed on the tab sheet.

The difference is explained with reference to FIG. 9(a) and FIG. 9(b). Document 722 shown in FIG. 9(a) is a document used for image forming on a tab sheet bundle wherein the number of the tab sheets configuring one tab sheet bundle is “5”. In case a width of document 722 in the sub-scanning direction is width X1 and a width of tab sheet 802 in the sub-scanning direction is width X3, a size difference between tab sheet 802 and document 722 is equivalent to width X2 which represents a width of tab section 802A. Image position calculation device 165 calculates the difference so that a position shifted by the difference in the sub-scanning direction becomes a position where the document image is formed on tab sheet 802. Then image control section 160 outputs an output condition including the image forming position along with an image forming command to printer section 400.

Printer section 400 forms the document image on the tab sheet based on the image forming position included in the output condition on receipt of the image forming command and the output condition. Namely, printer section 400 shifts the position of the document image in the sub-scanning direction according to the difference obtained by image position calculation device 165 and forms the document image on the tab sheet.

For example, as FIG. 9(b) shows, if a width of tab section 802A in the sub-scanning direction is width X2, printer section 400 forms the document image in a position which is shifted by the difference X2 in the sub-scanning direction on tab sheet 802. For example, printer section 400 (image writing section 40) shifts a staring position of writing an electrostatic latent image on photoconductive drum 51 by the difference X2 and forms the electrostatic image in the position shifted. Thereby, the document image is shifted by the difference X2 in the sub-scanning direction and transferred onto the tab sheet.

Also, tray selecting device 162 can automatically select the sheet tray on which the tab sheet is loaded, wherein the tab dividing number included in the print job information of the document image data is equal to the number of the tab sheets configuring one tab sheet bundle on the sheet tray. For example, on the setting screen shown in FIG. 6, by selecting “automatic sheet selection” instead of selecting a specific sheet tray, the operator can instruct image forming apparatus 1 to automatically select the sheet tray. Tray selection device 162 selects the sheet tray automatically on receipt of the command from UI section 300.

Because the number of the tab sheets configuring one tab sheet bundle and the identification data are related each other and stored in system memory 190, tray selection device 162 retrieves the identification data (number) of the sheet tray, in which the tab dividing number and the number of the tab sheets is equal each other, in system memory 190 with the tab dividing number included in the print job information as a retrieving condition. Then image control section 160 includes the number of the sheet tray in the output condition and outputs an image forming command to printer section 400. Meanwhile, this tray selection device 162 represents “tray selection device” of the present invention.

As the above, the tab dividing number of documents in which tab sections in the shape of rectangular or square are not provided and the sheet tray where the tab sheets are loaded wherein the number of the tab sheets loaded on the sheet tray is equal to the number of the tab sheets configuring one tub sheet bundle are automatically selected, then the document image is formed on the tab sheet loaded on the sheet tray. Thereby, the image can be formed on the tab sheets, which number is equal to the tab dividing number without carrying out complicated setting operation by the operator.

Also, tray selection device 162 may automatically select a sheet tray to which the tab dividing number as well as the sheet size conform. Because the tab size is memorized in system memory along with the number of the tab sheets configuring one tab sheet bundle in conjunction with the sheet tray identification data (number), tray selection device 162 can obtain the identification data (number) of the sheet tray, to which the tab dividing number and the size conform, from system memory 190 with the tab dividing number of documents included in the print job information and the size of the image included in the page information as the retrieving conditions. Then, image control section 160 includes the number of the sheet tray in the output condition and outputs the image forming command to printer section.

Also, after an error massage (warning) is displayed on display/operation section 301, if operator instructs image forming, the image can be formed on a sheet loaded on the designated sheet tray.

For example, along with the error message (warning), a selection screen to let the operator select whether image forming is carried out or ceased is displayed on display/operation section 301. The operator give an instruction to carry out or to cease image forming with reference to the selection screen. In case image forming is ordered, image control section 160 outputs an image forming command to printer section 400 along with the print job information. On the other hand, In case ceasing of image forming is ordered, image control section 160 outputs an image forming ceasing command to printer section 400.

Meanwhile, tab attribute setting device 161, tray selection device 162, tab dividing number setting device 163, judging device 164 and image position calculation device 165 can be configured with either hardware or software. For example, a function of each device can be conducted by image control section 160 (CPU) by executing a control program store in program memory 180.

### <Operation>

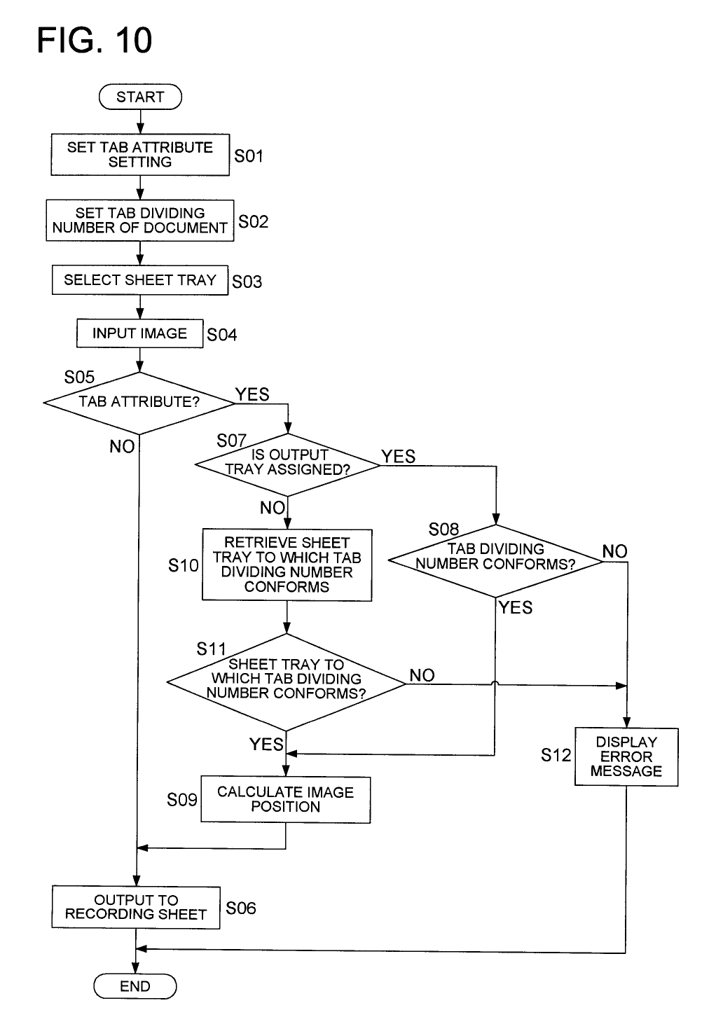

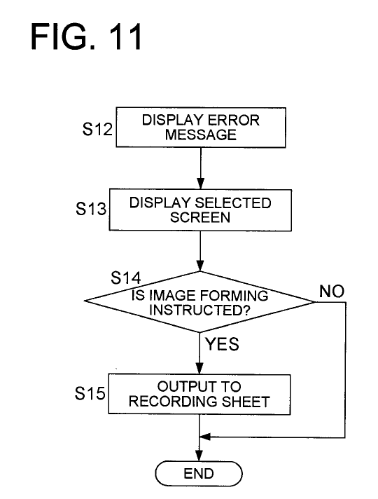

Next, a series of operations by the image forming apparatus related to the embodiment of the present invention is explained with reference to FIG. 10 and FIG. 11. FIG. 10 and FIG. 11 are flow charts showing the series of the operations on the image forming apparatus related to the embodiment of the present invention.

### <Step S01>

First, setting of the tab attribute in respect to the document is carried out. For example, the operator assigns a page where the image is formed in tab section among documents bundle in the shape of square or rectangular not having the tab section through display/operation section 301. In the example shown in FIG. 4, pages 1, 4, 8, 10 and 13 are assigned as the document for tab sheet. Here, the page numbers assigned are outputted to image control section 160.

### <Step S02>

Further, the tab dividing number of documents is set. For example, the operator inputs the tab dividing number of documents through display/operation section 301. In the example shown in FIG. 4, in case the images of documents 721 to 725 is formed on the tab sheet having the dividing number of “5”, in other word one set is configured with five tab sheets, the tab dividing number to form the image in an appropriate position is “5” and the value “5” is inputted. Here, the tab dividing number inputted is outputted from UI section 300 to image control section 160.

### <Step S03>

Next, the sheet tray on which the tab sheets for image forming are loaded is assigned. For, example, the operator assigns the identification data (number) of the desired sheet tray through display/operation section 301. Also, in case the sheet tray is automatically selected, the operator gives an instruction for automatic selection. Here, the identification data of the designated sheet tray or the instruction for automatic selection is outputted from UI section 300 to image forming control section 160.

Meanwhile, in the present embodiment, the number of the tab sheets configuring one tab sheet bundle is set in advance. For example, the operator inputs the number of the tab sheets configuring one tab sheet bundle through display/operation section 301. The number of the tab sheets inputted here is outputted from UI section 300 to image forming control section 160. Also, information such as the size and kind of the tab sheet can be inputted.

Then, tab dividing number setting device 163 relates the identification data of assigned sheet tray to the inputted number of the tab sheet, and stores them in system memory 190. Also, in case a plurality of sheet trays are assigned and the number of the tab sheets loaded on each tray are inputted, tab dividing number setting device 163 relates the identification data of each sheet tray to the inputted number of tab sheets for each sheet tray and stores them in system memory 190. Further, in case the size and the kind of the tab sheet are inputted, tab dividing number setting device 163 relates the size and the kind of the tab sheet to the identification data (number) of assigned sheet tray, and stores in system memory 190.

### <Step S04>

Next, scanner 200 scans the image formed on the document. A scanned document image data is compressed by compression section 120 and stored in compression memory 171 of image memory 170. At this stage, tab attribute setting device 161 adds the tab attribute information to the page information of the scanned document image data corresponding to the assigned page. Then this print jog is reserved under control of image control 160.

### <Step 05>

Then, when the image is formed on the recording sheet based to the print job under control of image control section 160, judging device 164 judges whether or not the tab attribute information is included in the page information of image data which is an object of the print job. In case the tab attribute information is included, it means that the image data is an image data to be formed on the tab sheet, and whether or not the image is for the tab sheet can be judged by presence of this tab attribute information.

### <Step S05 and Step S06>

In case the tab attribute information is not included in the page information of the image data (step S05, No), image control section 160 outputs an image forming command to printer section 400. In this case, image is not formed on the tab sheet, and printer section 400 forms the image on the recording sheet loaded on the assigned sheet tray.

### <Step S05 and Step S07>

On the other hand, in case the tab attribute information is included in the page information of the image data (step S05, Yes), judging device 164 further judges whether or not the sheet tray is assigned. If the identification data (number) of the sheet tray is included in the print job information, judging device 164 judges that the sheet tray is assigned.

### <Step S07 and step S08>

In case the sheet tray is assigned (step S07, yes), judging device 164 compares the tab dividing number of documents included in the print job information and the number of the tab sheets configuring one tab sheet bundle corresponding to the assigned sheet tray, then judges whether or not these numbers are equal each other (step S08).

### <Step S08 and Step S09>

Then, in case the tab dividing number of documents and the number of the tab sheets configuring one tab sheet bundle are equal (step S08, Yes), image position calculation device 165 calculates an amount of a difference of size between the document image and the tab sheet in the projecting direction of the tab section, then a position shifted by the amount of the difference in the projecting direction of the tab section becomes a position where the document image is formed on the tab sheet (step S09). Image control section 160 outputs an output condition including information of the image forming position to printer section 400.

### <Step S06>

Then, printer section 400 forms the image in the position shifted by the amount of the difference on the tab sheet based on the image forming position obtained in step S09. Namely, printer section 400 shifts the image forming position according to the amount of the difference to form the image in the tab section.

### <Step S08 and step S12>

On the other hand, in case the tab dividing number and the number of the tab sheets configuring one tab sheet bundle are not equal each other (step S08, No), Image control section 160 outputs a message of discrepancy to UI section 300. Then on receipt of the massage of discrepancy, interface control section 302 causes display/operation section 301 to display an error message (warning) as shown in FIG. 8 for example (step S12). Further, image control section 160 outputs an image forming ceasing command to printer section 400. Thereby printer section 400 does not form the image and a process of this print job is terminated.

### <Step S07 and Step S10>

Also, in case the sheet tray is not assigned and the print job information does not include the identification number of the sheet tray (step S07, No), the sheet tray is to be selected automatically, thus tray selection device 162 retrieves the sheet tray on which the tab sheet is loaded, wherein the number of tab sheets configuring one tab sheet bundle loaded on the sheet tray is equal to tab dividing number of documents (step S10). Namely, in system memory 190, since the number of tab sheets configuring one tab sheet bundle and the identification data (number) of the sheet tray are stored, corresponding each other, tray selection device 162 obtains the identification data (number) of the sheet tray where the tab dividing number of documents and the number of the tab sheet is equal, from system memory 190 with the tab dividing number of document as the condition of retrieving.

### <Step S11, step S09 and Step S06>

In case the identification data (number) of the sheet tray conforming to the condition of retrieval exists in system memory 190 (step S11, Yes), tray selection device 162 obtains the identification data of the sheet tray. Then image position calculation device 165 calculates the amount of the difference in size between the document image and the tab sheet in the projecting direction of the tab section, and finds the position where the document image is formed on the tab sheet (step S09). And then printer section 400 shifts the position where the document image is formed by the amount of the difference so as to form the document image on the tab sheet (step S06).

### <Step S11 and Step S12>

On the other hand, in case the identification data (number) of the sheet tray conforming to the condition of retrieval do not exist in system memory 190 (step S11, No), image control section 160 outputs a message of discrepancy to UI section 300. Then on receipt of the massage of discrepancy, interface control section 302 causes display/operation section 301 to display an error message (warning) shown in FIG. 8 (step S12). Further, image forming section 160 outputs an image forming ceasing command to printer section 400.

As the above, in case the tab dividing number of documents is not equal to the number of tab sheets configuring one tab sheet bundle, since image forming is not carried out, a failure that the image for the tab section is formed in a position deviated from tab section can be prevented.

Also, in case the tab dividing number of documents is not equal to the number of tab sheets configuring one tab sheet bundle, the operator can select execution or ceasing of image forming. This process is explained with reference to a flow chart of FIG. 11.

### <Step S12 and Step S13>

In case the tab dividing number of documents is not equal to the number of tab sheets configuring one tab sheet bundle, interface control section 302 causes display/operation section 301 to display an error massage (warning) on it (step S12) and then causes display/operation section 301 to display a selection screen to let the operator to select execution or ceasing of image forming (step S13). The operator can give an instruction of execution or ceasing of image forming on this selection screen.

### <Step S14 and Step S15>

In case image forming is ordered (step S14, Yes), image control section 160 outputs the image forming command to printer section 400. Then printer section 400 forms the image on the sheet loaded on the assigned sheet tray (step S15). On the other hand, in case ceasing is ordered (step S14, No), image control section 160 outputs the image forming ceasing command to printer section 400. Thereby, printer section 400 ceases image forming and the process is terminated.

As the above, even in case the tab dividing number of documents is not equal to the number of tab sheets configuring one tab sheet bundle, it is possible to continue image forming depending on a request of the operator.

### Second Embodiment

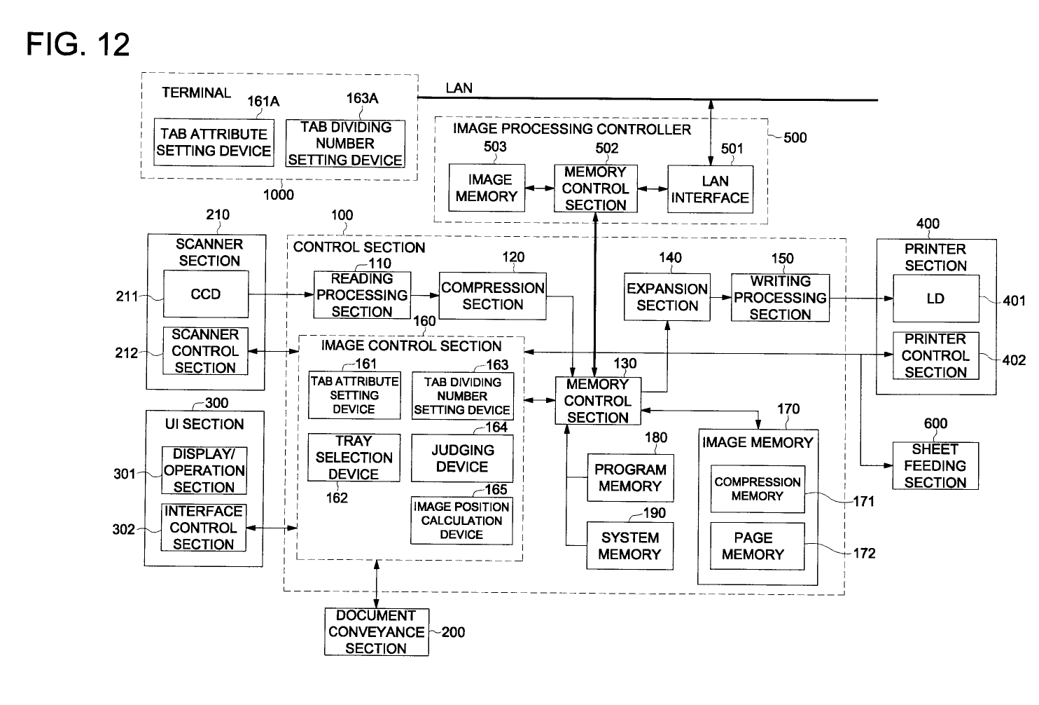

Next, an image forming apparatus related to a second embodiment of the present invention is explained with reference to FIG. 12. FIG. 12 is a block diagram showing schematic configuration of the image forming apparatus related to a second embodiment of the present invention.

In the embodiment, a case where instruction of image forming is conducted through a terminal 1000 connected to image forming apparatus 1 via a network is explained. The terminal 1000 is provided with tab attribute setting device 161A and tab dividing number setting device 163A corresponding to tab attribute setting device 161 and tab dividing number setting device 163 in the first embodiment respectively. Tab attribute setting device 161A has the same function as that of attribute setting device 161 in the first embodiment, and tab dividing number setting device 163A has the same function as that of tab dividing number setting device 163 in the first embodiment.

In this embodiment, setting of the tab attribute and setting of the tab dividing number of documents are conducted in terminal 1000. This aspect where the settings thereof are conducted in terminal 1000 is a difference from the first embodiment and other configurations are the same as that of fist embodiment. Therefore, in the following explanation, differences are mainly explained and portions having the same configurations are explained briefly.

Tab attribute setting device 161A to terminal 1000 adds the tab attribute information to the page information of the document image data to be outputted to image forming apparatus 1 and adds the tab dividing number of documents image data to the print job information. The page number of the document image data, which forms the image on the tab sheet, and the tab dividing number of documents are inputted by the operator on terminal 1000.

Tab dividing number setting device 163A relates the identification data (number) of the sheet tray provided in image forming apparatus 1 assigned by the operator on terminal 1000 to the number of the tab sheets configuring one set of the tab sheet bundle. This relationship is memorized in system memory 190 of image forming apparatus 1 through the network. Also, in case a plurality of the sheet trays are assigned and the number of the tab sheets configuring one tab sheet bundle loaded on each sheet tray is inputted, tab dividing number setting device 163A relates the identification data of each sheet tray to the number of the tab sheets inputted for each tray. Further, in case information such as the size and the kind of the tab sheet are inputted, tab dividing number setting device 163A also relates information such as the size and the kind of the tab sheet to the identification data (number) of the assigned sheet tray.

As above, when setting of the tab attribute and assigning of the tab dividing number of documents are conducted, the document image data is inputted to image forming apparatus 1 via the network. Then the print job of the document image data is reserved under control of image control section 160.

Then judging device 164 judges whether or not the tab attribute information is included in the page information of the image data which is an object of the print job. If the tab attribute information is included in the page information, judging device 164 further judges whether or not the sheet tray is assigned. An then in case the sheet tray is assigned and the identification data (number) of the sheet tray is included in the print job information, the tab dividing number of documents included in the print job information are compared with the number of the tab sheet corresponding to the identification data of the sheet tray in the same manner as in the first embodiment, and whether or not the tab dividing number of documents and the number of the tab sheets configuring one tab sheet bundle are equal each other is judged.

In case the tab dividing number of documents and the number of the tab sheet configuring one tab sheet bundle are equal, image position calculation device 165 calculates the amount of the difference in size between the document image and the tab sheet in the projecting direction of the tab section, then the position shifted by the amount of the difference is designated as the image forming position. And then image control section 160 outputs the image forming command to printer section 400. Printer section 400 forms the image on receipt on the image forming command.

On the other hand, In case the tab dividing number of documents and the number of the tab sheets configuring one tab sheet bundle are not equal, image control section 160 outputs the image forming ceasing command to printer section 400 and the message of discrepancy is outputted to terminal 1000 through image processing controller 500 and the network. Thereby, image forming is ceased and the error massage (warning) is displayed on terminal 1000, further the error massage (warning) is displayed on display/operation control section 301.

Also, in case the sheet tray is not assigned, sheet tray selection device 162, selects the sheet tray wherein the number of the tab sheets configuring one tab sheet bundle loaded on the sheet tray are is equal to the tab dividing number of documents, with the tab dividing number of documents included in the print job information as a condition of retrieval, in the same manner as in the first embodiment. Then judging device 164 compares the number of the tab sheet corresponding to the identification data of the sheet tray and the tab dividing number of documents included in the print job information so as to judge whether the tab dividing number of documents is equal to the number of the tab sheets configuring one tab sheet bundle. Then in case the tab dividing number of documents is equal to the number of the tab sheet, printer section 400 forms the image in the same manner as above. On the other hand, in case the tab dividing number of documents is not equal to the number of the tab sheet, information indicating discrepancy is sent to terminal 100 to cease image forming. Thereby the error massage (warning) is displayed on terminal 1000. Further, image control section 160 may output a message of discrepancy to UI section 300. Thus, the error massage (warning) is displayed on display/operation section 301.

As the above, even in case the image forming command is sent from the terminal 1000 connected to the image forming apparatus via a network, the same operation and effect can be realized as that of the first embodiment. Namely, in case the tab dividing number of documents and the number of the tab sheets are not equal, since the image forming is not carried out a failure of image forming caused by discrepancy between the tab dividing number and the number of the tab sheets can be prevented.

Also, by automatically selecting the sheet tray wherein the number of the tab sheets loaded on the sheet tray are is equal to the tab dividing number of documents, complicated assigning work is not necessary and it becomes possible that an load of the operator is relieved.

According to the embodiments thereof, the tab attribute information and the tab dividing number are related to the image data of the document image, the tab dividing number of documents is compared with the number of tab sheets configuring one tab sheet bundle, an warning is caused when the numbers are not equal, and image forming is ceased. Thereby, it becomes possible to prevent the failure of image forming caused by discrepancy between the tab dividing number and the number of tab sheets configuring one tab sheet bundle.

Also, it becomes possible to eliminate operator's complicated assigning work for forming the image on the tab sheet wherein the tab diving number of documents and the number of the tab sheet is equal, by automatically selecting the sheet tray, wherein the number of the tab sheets configuring one tab sheet bundle loaded on the sheet tray is equal to the tab dividing number of documents so as to form the document image on the tab sheet loaded on the selected sheet tray.

What is claimed is:

1. An image forming apparatus to form an image on a tab sheet provided with the tab section projecting at a prescribed position, comprising:
an inputting section to input a tab dividing number of documents, tab attribute information to indicate forming of an image on the tab sheet and number of the tab sheets configuring one tab sheet bundle;
a memory section to memorize and connect the tab dividing number of documents, the tab attribute information and image data of the document image each other;
a judging section to judge whether or not the tab dividing number of documents and the number of tab sheets configuring one tab sheet bundle are equal by comparing the tab dividing number of documents and the number of the tab sheets configuring one tab sheet bundle when the image is formed on the tab sheet based on the image data to which the tab attribute information is connected; and
a control section to control the image forming apparatus based on a result of a judgment by the judging section.

2. The image forming apparatus of claim 1, wherein the control section announces discrepancy through announcing section when the judging section judges to be unequal.

3. The image forming apparatus of claim 1, wherein the control section prohibits to form the image on the tab sheet when the judging section judges to be unequal.

4. The image forming apparatus of claim 1, wherein the control section shifts the image to which the tab attribute information is connected, in accordance with an amount of a difference between a size of the tab sheet in a projecting direction of the tab section and a size of the image to which the tab attribute information is connected in the projecting direction of the tab section, so as to form the image on the tab sheet.

5. The image forming apparatus of claim 1, wherein the control section displays a selection screen on which execution or ceasing of image forming is selected on a display section when the judging section judges to be unequal.

6. An image forming apparatus to form a image on a tab sheet provided with the tab section projecting at a prescribed position, comprising:
an inputting section to input a tab dividing number of documents, tab attribute information to indicate forming of an image on the tab sheet, and number of the tab sheets configuring one tab sheet bundle;
a memory section to memorize and connect the tab dividing number of documents, the tab attribute information and image data of the document image each other;
a sheet tray selecting section to select a sheet tray, wherein the number of the tab sheets configuring one tab sheet bundle loaded on the sheet tray is equal to the tab dividing number of document; and
a control section to shift the image to which the tab attribute information is connected in accordance with an amount of a difference between a size of the tab sheet in a projecting direction of the tab section and a size of the image to which the tab attribute information is connected in the projecting direction of the tab section, and to form the image on the tab sheet which is loaded on the selected sheet tray.

7. The image forming apparatus of claim 6, further comprising:
a second memory section to memorize and relate the number of the tab sheets configuring one tab sheet bundle loaded on the sheet tray to the sheet tray;
wherein based on information of the second memory section, the sheet tray selecting section selects the sheet tray to which the same number as the tab dividing number of documents is related.

8. A computer-readable storage medium having a computer program stored thereon that is readable by a computer for controlling an image forming apparatus which forms an image on a tab sheet provided with the tab section projecting at a prescribed position, wherein the computer program causes the computer to execute steps of:
inputting a tab dividing number of documents, tab attribute information to indicate forming of an image on the tab sheet and number of the tab sheets configuring one tab sheet bundle;
memorizing and connecting the tab dividing number of documents, the tab attribute information and the image data of the document image each other;
judging whether or not the tab dividing number of documents and the number of tab sheets configuring one tab sheet bundle are equal by comparing the tab dividing number of documents and the number of the tab sheets configuring one tab sheet bundle when the image is formed on the tab sheet based on the image data to which the tab attribute information is connected; and
controlling the image forming apparatus base on a result of a judgment by the judging step.

9. The computer-readable storage medium of claim 8, wherein the controlling step announces discrepancy through an announcing section when the judging step judges to be unequal.

10. The computer-readable storage medium of claim 8, wherein the controlling step prohibits forming of the image on the tab sheet when the judging step judges to be unequal.

11. The computer-readable storage medium of claim 8, wherein a controlling step shifts the image to which the tab attribute information is connected in accordance with an amount of a difference between a size of the tab sheet in a projecting direction of the tab section and a size of the image to which the tab attribute information is connected in the projecting direction of the tab section, so as to form the image on the tab sheet which is loaded on the selected sheet tray.

12. The computer-readable storage medium of claim 8, wherein the controlling step displays a selection screen, on which execution or ceasing of image forming is selected, on a display section when the judging step judges to be unequal.

13. A computer-readable storage medium having a computer program stored thereon that is readable by a computer for controlling an image forming apparatus which forms an image on a tab sheet provided with the tab section projecting at a prescribed position, wherein the computer program causes the computer to execute steps of:
inputting a tab dividing number of documents, tab attribute information to indicate forming of an image on the tab sheet and number of the tab sheets configuring one tab sheet bundle loaded on the sheet tray;
memorizing and connecting the tab dividing number of documents, the tab attribute information and the image data of the document image each other;
selecting a sheet tray wherein the number of the tab sheets configuring one tab sheet bundle loaded on the sheet tray is equal to the tab dividing number of documents; and
shifting the image to which the tab attribute information is connected in accordance with an amount of a difference between a size of the tab sheet in a projecting direction of the tab section and a size of the image to which the tab attribute information is connected in the projecting direction of the tab section, and to form the image on the tab sheet which is loaded on the selected sheet tray.

14. An image forming method to form an image on a tab sheet provided with the tab section projecting at a prescribed position, comprising steps of:
inputting a tab dividing number documents, tab attribute information to indicate forming of an image on the tab sheet, and number of the tab sheets configuring one tab sheet bundle;
memorizing and connecting the tab dividing number of documents, the tab attribute information and image data of the document image each other;
judging whether or not the tab dividing number of documents and the number of tab sheets configuring one tab sheet bundle are equal by comparing the tab dividing number of documents and the number of tab sheets configuring one tab sheet bundle when the image is formed on the tab sheet based on the image data to which the tab attribute information is connected; and
announcing discrepancy between the tab dividing number of documents and the number of the tab sheets configuring one tab sheet bundle when the numbers thereof are judged to be unequal.

15. An image forming method to form an image on a tab sheet provided with the tab section projecting at a prescribed position, comprising steps of:
inputting a tab dividing number of documents, tab attribute information to indicate forming of an image on the tab sheet, and number of the tab sheets configuring one tab sheet bundle;
memorizing and connecting the tab dividing number of documents, the tab attribute information and image data of the document image each other;
judging whether or not the tab dividing number of documents and the number of tab sheets configuring one tab sheet bundle are equal by comparing the tab dividing number of documents and the number of tab sheets configuring one tab sheet bundle when the image is formed on the tab sheet based on the image data to which the tab attribute information is connected; and
shifting the image to which the tab attribute information is connected, in accordance with an amount of a difference between a size of the tab sheet in a projecting direction of the tab section and a size of the image to which the tab attribute information is connected in the projecting direction of the tab section, and forming the image on the tab sheet which is loaded on the selected sheet tray when the tab dividing number of documents and the number of tab sheets configuring one tab sheet bundle are judged to be equal.

16. An image forming method to form an image on a tab sheet provided with the tab section projecting at a prescribed position, comprising steps of:
inputting a tab dividing number of documents, tab attribute information to indicate forming of an image on the tab sheet, and number of the tab sheets configuring one tab sheet bundle;
memorizing and connecting the tab dividing number of documents, the tab attribute information and image data of the document image each other;
selecting a sheet tray wherein the number of the tab sheets configuring one tab sheet bundle loaded on the sheet tray is equal to the tab dividing number of documents; and
shifting the image to which the tab attribute information is connected in accordance with an amount of a difference between a size of the tab sheet in a projecting direction of the tab section and a size of the image to which the tab attribute information is connected in the projecting direction of the tab section, and forming the image on the tab sheet which is loaded on the selected sheet.

17. An image forming system to form an image on a tab sheet provided with the tab section projecting at a prescribed position, comprising:
an inputting section to input a tab dividing number of documents, tab attribute information to indicate forming of an image on the tab sheet, and number of the tab sheets configuring one tab sheet bundle;
a memory section to memorize and connect the tab dividing number of documents, the tab attribute information and image data of the document image each other;
a judging section to judge whether or not the tab dividing number of documents and the number of tab sheets configuring one tab sheet bundle are equal by comparing the tab dividing number of documents and the number of tab sheets configuring one tab sheet bundle when the image is formed on the tab sheet based on the image data to which the tab attribute information is connected; and
a control section to control an image forming apparatus based on a judgment result of the judging section.

18. The image forming system of claim 17, wherein the control section announces discrepancy through an announcing section when the judging section judges to be unequal.

19. The image forming system of claim 17, wherein the control section prohibits to form the image on the tab sheet when the judging section judges to be unequal.

20. An image forming system to form an image on a tab sheet provided with the tab section projecting at a prescribed position, comprising:
an inputting section to input a tab dividing number of documents, tab attribute information to indicate forming of an image on the tab sheet, image data of the document image and number of the tab sheets configuring one tab sheet bundle loaded on the sheet tray;
a memory section to memorize and connect the tab dividing number of documents, the tab attribute information and image data of the document image each other;
a sheet tray selection section to select a sheet tray, wherein the number of the tab sheets configuring one tab sheet bundle loaded on the sheet tray is equal to the tab dividing number of documents; and a control section to shift the image to which the tab attribute information is connected in accordance with an amount of a difference between a size of the tab sheet in a projecting direction of the tab section and a size of the image to which the tab attribute information is connected in the projecting direction of the tab section, and to form the image on the tab sheet which is loaded on the selected sheet tray.
